(19) United States
(12) Patent Application Publication
(10) Pub. No.: US 2018/0257205 A1
(43) Pub. Date: Sep. 13, 2018

(54) MULTIPURPOSE TIRE TOOL

(71) Applicant: Thomas Wood, Lancaster, CA (US)

(72) Inventor: Thomas Wood, Lancaster, CA (US)

(21) Appl. No.: 15/910,368

(22) Filed: Mar. 2, 2018

Related U.S. Application Data
(60) Provisional application No. 62/469,028, filed on Mar. 9, 2017.

(51) Int. Cl. B25B 27/00; B25B 15/02; B25B 23/00; B60C 25/18

(52) U.S. Cl. CPC B25B 27/0035; B25B 15/02; B25G 1/102; B60C 25/18; B25B 23/0035

(57) ABSTRACT

A multipurpose tire tool for quickly and easily removing and inserting valve stem cores and sensors for a tire pressure monitoring system (TPMS). Such a tool has a central body with a proximal end and a distal end. The tool further includes a variety of elements used in the removal and insertion of valve stem cores and sensors associated with TPMS. These elements may include, but are not limited to, one or more Philips head screwdriver inserts or bits, a T-10 insert or bit, a valve a core replacement tool, and a tire air fitting. In practice, the tool may be oriented in any of a variety of fashions to quickly and easily be inserted into valve stems for the removal of valve stem cores and replacement of TPMS on a wheel of an automobile.

### CROSS REFERENCE TO RELATED APPLICATIONS

This application claims priority from U.S. Provisional Patent Application Ser. No. 62/469,028, filed Mar. 9, 2017, the entire contents of which are hereby incorporated by reference.

### BACKGROUND

Tire pressure monitoring systems are required on new automobiles sold in many jurisdictions. In the United States, for any vehicle made after Sep. 1, 2007, each new vehicle must include a tire pressure monitoring system (TPMS) in order for the vehicle to be legal. As a result, in the U.S. and elsewhere, such systems have become standard on many new automobiles.

A TPMS provides real time monitoring of the air or gas pressure in each tire of the automobile it is associated with. Such systems are routinely used to alert drivers or technicians that a tire is underinflated or to help provide a visual representation of a tire having a leak.

While useful for monitoring tire pressure, the valve stems and sensors associated with TPMS systems often require removal or replacement. For example, if a worn tire is being replaced the valve stem and sensor associated with a TPMS for that tire must be removed and reapplied to a new tire when it is mounted on the wheel. Additionally, TPMS valve stems, which are often formed of aluminum, have been known to corrode or otherwise fail, thus necessitating replacement.

In such situations, a technician must use a number of tools to remove and/or replace the valves stem on a wheel. The valve stems, however, often have minimal clearance on the barrel of a wheel, causing difficult tool fitment or increasing the possibility of damaging or otherwise marking the wheel. Additionally, in order to properly remove and/or replace or refit a valve stem, multiple tools are needed due to the various fastening elements on most valve stems. As such, it is often difficult to find the appropriate tools or convenient tools, which leads to increased time to service an automobile or possible damage to a wheel when working with a TPMS valve stem.

### SUMMARY

According to an exemplary embodiment, a tire tool for quickly and easily removing and inserting valve stem cores and sensors for a tire pressure monitoring system may be shown and described.

Such a tool may include: a handle that has a first opening and a second opening at each side of a distal end of the handle; a bit that is detachably accommodated by the first opening of the handle and has at least one screwdriver head at a distal end of the bit; a core replacement tool that is accommodated by the second opening of the handle and has a base portion and an end portion; and a tire air fitting that is detachably coupled to the handle over the core replacement tool.

In another exemplary embodiment, a method for replacing a tire pressure monitoring system (TPMS) by using the tire tool may be described. Such a method may include: removing, by a core replacement tool of a tire tool, a valve stem core from a valve stem of a tire; removing, by a bit of the tire tool, a first TPMS sensor from the valve stem and a tire wheel; mounting, by the bit of the tire tool, a second TPMS sensor on the valve stem and the tire wheel; fastening a tire air fitting detached from the tire tool on the valve stem to inflate the tire; removing the tire air fitting from the valve stem; and re-installing, by the core replacement tool, the valve stem core on the valve stem. In an exemplary embodiment, the tire tool has a handle that has a first opening and a second opening at each side of a distal end of the handle, the bit is detachably accommodated by the first opening of the handle and has at least one screwdriver head at a distal end of the bit, the core replacement tool is accommodated by the second opening of the handle and has a base portion and an end portion, and the tire air fitting is detachably coupled to the handle over the core replacement tool.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary diagram of an exploded view of a tool;

FIG. 2 is an exemplary diagram showing a handle of a tool;

FIG. 3 is an exemplary diagram showing bits of a tool;

FIG. 4 is an exemplary diagram showing a tire air fitting and a core replacement tool;

FIG. 5 is another exemplary diagram of an exploded view of a tool;

FIG. 6 is an exemplary diagram of a tool with elements decoupled;

FIG. 7 is an exemplary diagram of a tool with elements coupled;

FIG. 8 is another exemplary diagram of an exploded view of a tool with a pocket clip and a replaceable core replacement tool;

FIG. 9 is an exemplary diagram showing a replaceable core replacement tool and a handle; and

FIG. 10 is an exemplary diagram showing a pocket clip.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

According to an exemplary embodiment, and referring generally to the Figures, various exemplary implementations of a tool used for repairing and replacing valve stems and tire pressure sensors for wheels and tires having tire pressuring monitoring systems (TPMS) may be shown and described.

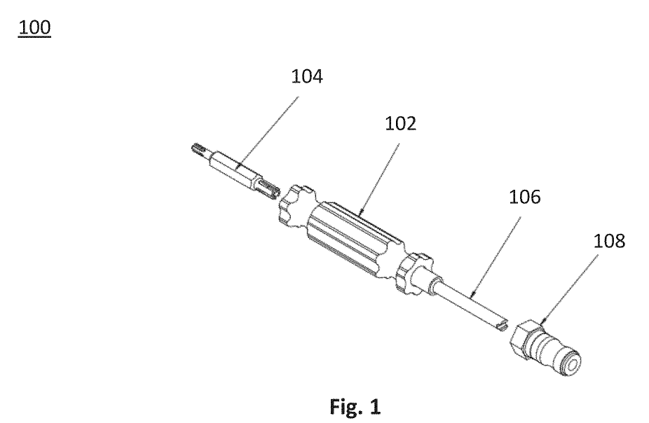

Turning now to exemplary FIG. 1, a tool 100 having a number of components may be shown. Tool 100 may have a handle 102. Handle 102 may be substantially cylindrical or formed with a number of ridges, grips, knurls, or other elements to facilitate being held and actuated by a user, as may be generally known. Additionally, it may be appreciated that handle 102, along with any other elements of tool 100, may be formed in any shape or size, although exemplary dimensions may be provided herein. Further, it may be appreciated that tool 100, and its elements, may be formed out of any material or combination of materials, as desired. It is envisioned that in order to provide ease of use, grip, and familiarity, tool 100 may be formed out of various combinations of materials known in the manufacture or other similar hand tools, such as screwdrivers.

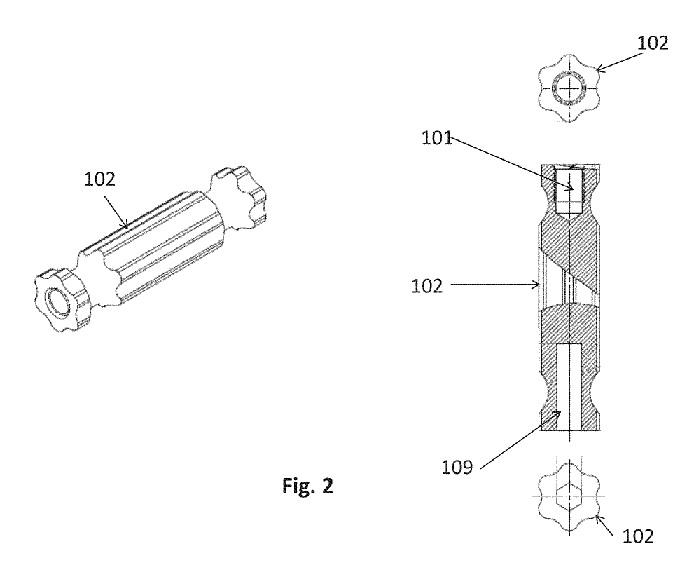

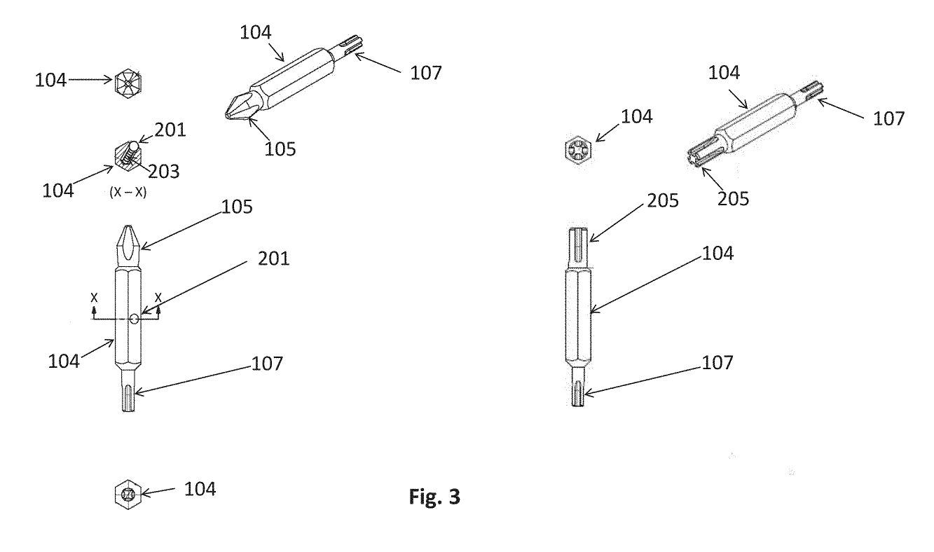

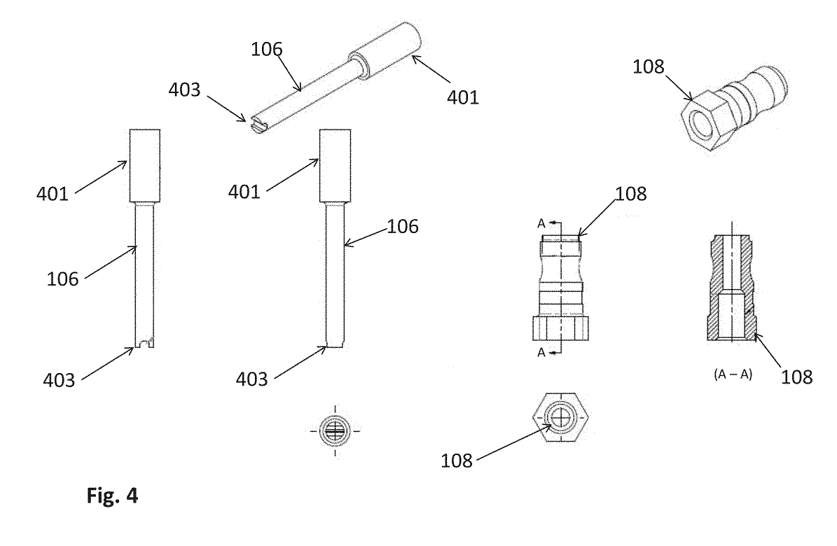

Handle 102 may be approximately 2.75″ long and have a cross section of about 0.625″. A first opening 109 (as seen in exemplary FIG. 2) has a depth of about 0.900″ and a cross section of about ¼″, and the first opening 109 may receive bit 104 (shown in exemplary FIG. 3) which may have a depth of about 1.8″ and a cross section of about ¼″. Additionally, handle 102 may have a second opening 101 that accommodates core removal tool 106 (shown in exemplary FIG. 4).

At a distal end of tool 100 there may be a first opening 109 or a second opening 101 (FIG. 2). The first opening 109 may be used to securely receive bit 104, which may have a first end 105 and a second end 107, also shown in exemplary FIG. 3. Bit 104 may have a cross section of about ¼″, for example 0.248″, and bit 104 may have a length of about 1.8″. Bit 104 may be such that the first end 105 has a Philips head screwdriver formed thereon. The first end 105 may be a Phillips ⅛″ bit. The second end 107 of bit 104 may have a T-10 Torx bit, for example measuring 3/16″. Also, in another exemplary embodiment, one of the end (105 or 107) of bit 104 may be T-XX Torx bit 205. Additionally, bit 104 may be formed in any desired shape, such as a hexagonal shape; however, it may be appreciated that bit 104 and the first opening 109 into which it is received and held may be formed as substantially similar shapes so as to facilitate securely holding bit 104 in tool 100 when in use or not in use.

Additionally, bit 104 may have one or more security devices disposed on its body, for example a depressible locking mechanism that may fit inside a corresponding locking receiver inside handle 102 of tool 100. According to an exemplary embodiment, a mechanism of a retractable ball may be applied to the locking mechanism. In an exemplary embodiment, a detent ball 201 may be loaded with a spring 203 and may retract and extend outside bit 104 for bit 104 to be locked inside of the opening 109 of the handle 102. Other locking mechanisms or techniques, such as magnetism, threading, and the like, may be utilized as desired. Additionally, any other ¼″ bit may be inserted and secured in the first opening 109 as desired. When in an operating position, bit 104 may be secured inside handle 102 so as to function as a screwdriver in a known manner.

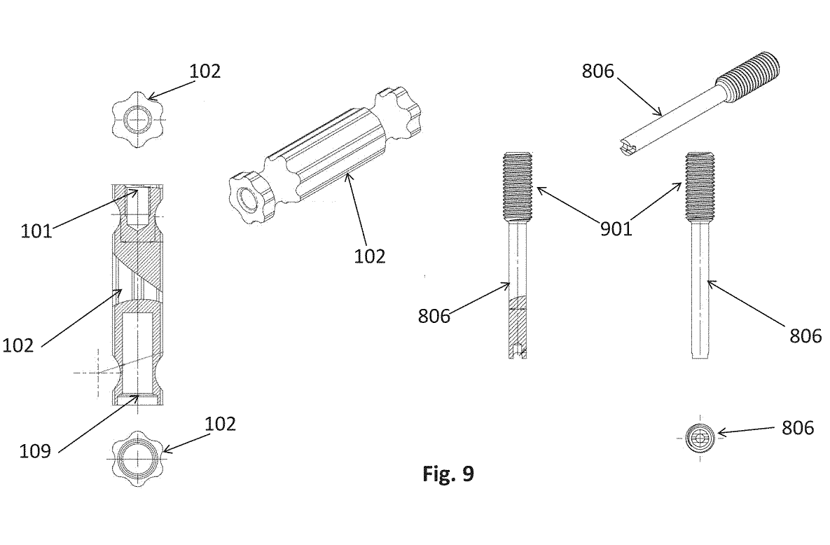

Referring now also to exemplary FIG. 4, a proximate end of handle 102, near the second opening 101, may have various separable elements, including insect bit (not shown in drawings) or core replacement tool 106 and tire air fitting 108, also shown in exemplary FIG. 4. Core replacement tool 106 may be formed so as to be fixed with respect to handle 102, for example using the base portion 401 of core replacement tool 106 in the second opening 101. It is envisioned that core removal tool 106 may also be detachable, however. Additionally, core replacement tool 106 may be formed to have a length of approximately 2.250″ from tip to base and a diameter of about 0.188″. Core replacement tool 106 may have a base portion 401 that is approximately 0.75″ from tip to base and may further have a substantially “U”-shaped end portion 403 having a height of about 0.063″ from the base of the “U” to the end, an overall diameter of about 0.188″, and a distance between arms of the “U” of about 0.094″. Also, core replacement tool 106 may have threading disposed thereon (as seen in exemplary FIG. 9) in order to facilitate secure coupling with tire air fitting 108. Core replacement tool 106 may be utilized for quickly loosening and removing, or securing, tire valve stem cores, as is known in the art.

Further, tire air fitting 108 may be formed so that it can be received over core replacement tool 106. Tire air fitting 108, which may be an industry-known CP-12 fitting, may be used after a valve stem is seated to facilitate rapid inflation of the tire. As shown in exemplary FIG. 4, tire air fitting 108 may have a substantially hollow central portion or threaded central portion that allows it to be securely seated, or fit over, core replacement tool 106. Similar to the above exemplary embodiments with respect to bit 104, any desired manner may be used to securely seat tire air fitting 108 over core replacement tool 106. Additionally, while it may be appreciated that tire air fitting 108 may have industry-known standard dimensions, it is also envisioned that other dimensions of tire air fittings for lesser known or non-standard valves may be utilized herein. Further, threading disposed on an interior portion of tire air fitting 108 may also allow it to be threadably secured to a tire valve stem prior to inflating a tire. However, tire air fitting 108 may also be secured to core removal tool 106 or handle 102 of tool 100 in any desired fashion.

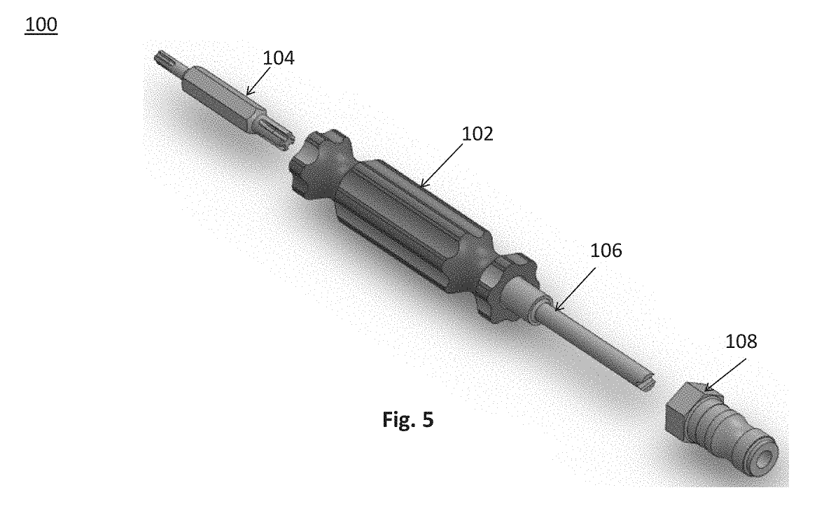

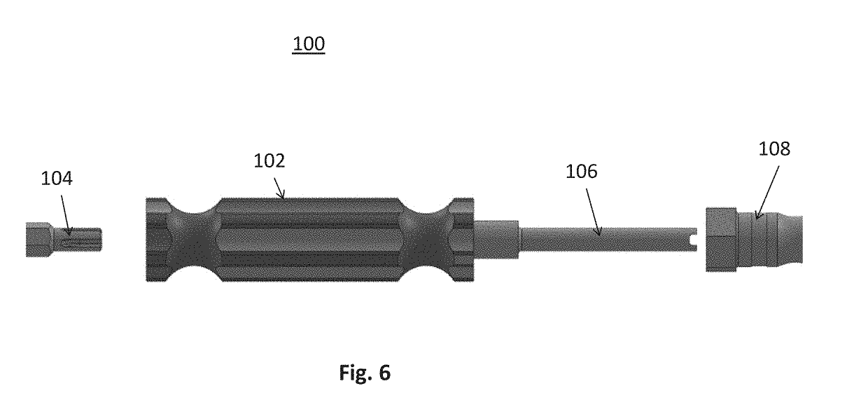

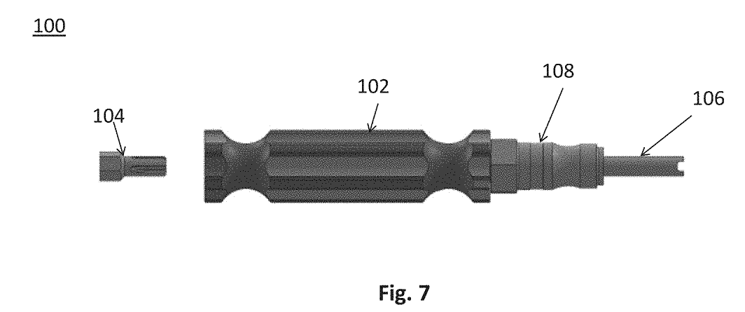

Exemplary FIGS. 5, 6, and 7 show other views of tool 100 and the various fittings associated with it in a disassembled fashion and various assembled and operational fashions.

In use, tool 100 may replace many different, individual tools, such as a T-10, T-XX, or a Phillips head screwdriver, a valve remover tool, and a tire air fitting. Thus, in a further exemplary embodiment, tool 100 may be used to remove valve stems and TPMS sensors and replace them without the need to use or locate other tools.

For example, when it is desired to remove a valve stem core and/or replace a tire pressure sensor associated with a TPMS, a user may use core replacement tool 106 to remove a valve stem core. It may be noted that in an operational state, tool 100 may have tire air fitting 108 coupled or decoupled. However, in this exemplary embodiment, tire air fitting would be in a decoupled state from tool 100 and core replacement tool 106 so as to have core replacement tool 106 exposed. Core replacement tool 106 may then be inserted into a valve stem and turned to remove the valve stem core, as is known in the art. After core replacement tool 106 is used, tire air fitting 108 may be re-coupled or otherwise secured over core replacement tool 106 of tool 100.

After the valve stem core is removed by using core replacement tool 106, a user may then take action to remove a TPMS sensor. Generally speaking, TPMS sensors are secured to valve stems using a T-10 connection. Thus, bit 104 may be secured in handle 102 of tool 100 such that a T-10 bit which is provided on the second end 107 of bit 104 is in an operational position. The T-10 bit on the second end 107 may then be used to loosen the T-10 bolt of the TPMS sensor, allowing for removal of the sensor from the automobile wheel. A new TPMS sensor may then be mounted to the wheel and valve stem in a reverse fashion, using the T-10 bit on the second end 107. After this is complete, a tire may be mounted on the wheel.

It may be appreciated, in some exemplary embodiments, that various additional coupling or fastening elements of a TPMS sensor may use a Phillips head screw and, in such embodiments, bit 104 may be reversed allowing for the Phillips head screwdriver bit of bit 104 to be utilized.

After the TPMS sensor is replaced, tire air fitting 108 may be removed from tool 100 and fastened over the valve stem. An external air hose may then be used to quickly inflate the tire mounted on the wheel through the valve stem. The tire air fitting 108 may then be removed and the valve stem core may be reinstalled through the valve stem using core replacement tool 106. After this is complete, tool 100 may have tire air fitting 108 recoupled to it, over core replacement tool 106.

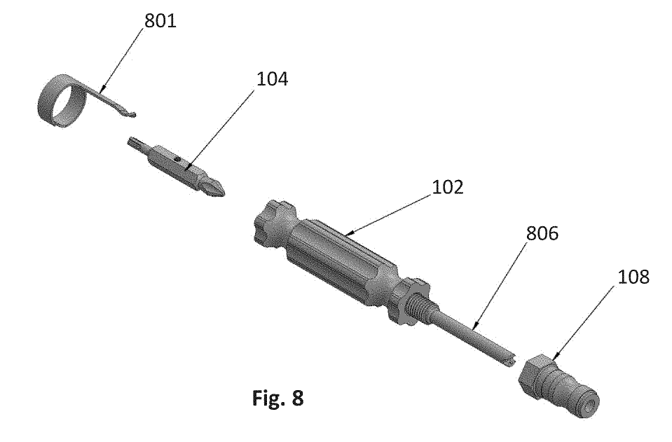

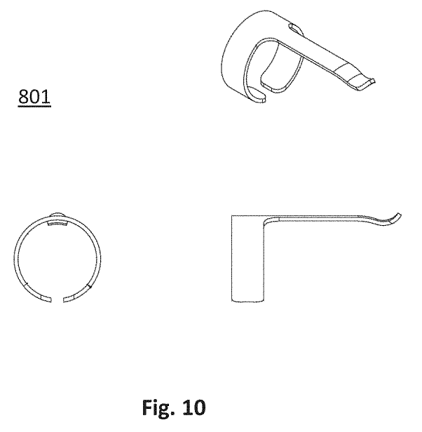

Turning now to exemplary FIGS. 8, 9 and 10, another exemplary embodiment of the tool may be described. In an exemplary embodiment, a replaceable core replacement tool 806 may be provided instead of the core replacement tool 106. Also, a pocket clip 801 may be provided on the handle 102. Referring to exemplary FIG. 9, the replaceable core replacement tool 806 may have threads 901, and the second opening 101 of the handle 102 may also have threads to accommodate the replaceable core replacement tool 806. According to an exemplary embodiment, the replaceable core replacement tool 806 may be replaced instead of discarded even though the core replacement tool is broken or worn out. Referring to exemplary FIG. 10, the pocket clip 801 may be designed with semi-flexible materials to be a type of a retaining ring, and may be snapped into the handle 102.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A tire tool comprising:
a handle that has a first opening at a first distal end of the handle and a second opening at a second distal end of the handle;
a bit that is detachably accommodated by the first opening of the handle and has at least one screwdriver head on at least one side of a distal end of the bit;
a core replacement tool that is accommodated by the second opening of the handle and has a base portion and an end portion; and
a tire air fitting that is detachably coupled to the handle over the core replacement tool.

2. The tire tool of claim 1, wherein the at least one screwdriver head of the bit is at least one of a Philips head, a Torx head and a hexagonal shaped head.

3. The tire tool of claim 1, wherein the first opening of the handle securely holds the bit via a depressible locking mechanism.

4. The tire tool of claim 1, wherein a spring-loaded detent ball is provided on the bit, and the spring-loaded detent ball retracts and extends on the bit to lock the bit inside of the first opening of the handle.

5. The tire tool of claim 1, wherein the base portion of the core replacement tool is fixedly accommodated by the second opening of the handle.

6. The tire tool of claim 1, wherein the base portion of the core replacement tool and the second opening of the handle is detachably coupled via threads.

7. The tire tool of claim 1, wherein the tire air fitting is detachably coupled to the second distal end of the handle over the core replacement tool via threads.

8. The tire tool of claim 1, wherein threads are disposed on an interior portion of the tire air fitting for the tire air fitting to be secured to a tire valve stem prior to inflating a tire.

9. The tire tool of claim 1, wherein the end portion of the core replacement tool has a U-shape to handle a tire valve.

10. The tire tool of claim 1, wherein a clip is provided on the handle.

11. A method for replacing a tire pressure monitoring system (TPMS) by using a multipurpose tire tool comprising
removing, by a core replacement tool of a tire tool, a valve stem core from a valve stem of a tire;
removing, by a bit of the tire tool, a first TPMS sensor from the valve stem and a tire wheel;
mounting, by the bit of the tire tool, a second TPMS sensor on the valve stem and the tire wheel;
detaching a tire air fitting from the tire tool;
fastening the tire air fitting on the valve stem to inflate the tire;
removing the tire air fitting from the valve stem; and
re-installing, by the core replacement tool, the valve stem core on the valve stem,
wherein the tire tool has a handle that has a first opening at a first distal end of the handle and a second opening at a second distal end of the handle,
wherein the bit is detachably accommodated by the first opening of the handle and has at least one screwdriver head on at least one side of a distal end of the bit,
wherein the core replacement tool is accommodated by the second opening of the handle and has a base portion and an end portion, and
wherein the tire air fitting is detachably coupled to the handle over the core replacement tool.

12. The tire tool of claim 11, wherein the at least one screwdriver head of the bit is at least one of a Philips head, a Torx head and a hexagonal shaped head.

13. The tire tool of claim 11, wherein the first opening of the handle securely holds the bit via a depressible locking mechanism.

14. The tire tool of claim 11, wherein a spring-loaded detent ball is provided on the bit, and the spring-loaded detent ball retracts and extends on the bit to lock the bit inside of the first opening of the handle.

15. The tire tool of claim 11, wherein the base portion of the core replacement tool is fixedly accommodated by the second opening of the handle.

16. The tire tool of claim 11, wherein the base portion of the core replacement tool and the second opening of the handle is detachably coupled via threads.

17. The tire tool of claim 11, wherein the tire air fitting is detachably coupled to the second distal end of the handle over the core replacement tool via threads.

18. The tire tool of claim 11, wherein threads are disposed on an interior portion of the tire air fitting for the tire air fitting to be secured to a tire valve stem prior to inflating a tire.

19. The tire tool of claim 11, wherein the end portion of the core replacement tool has a U-shape to handle a tire valve.

20. The tire tool of claim 11, wherein a clip is provided on the handle.
